(19) United States
(12) Patent Application Publication
(10) Pub. No.: US 2021/0276512 A1
(43) Pub. Date: Sep. 9, 2021

(54) SYSTEMS AND METHODS FOR REDUCING POWER CONSUMPTION IN A SMART KEY OF A VEHICLE

(71) Applicant: Ford Global Technologies, LLC, Dearborn, MI (US)

(72) Inventors: Vivekanandh Elangovan, Canton, MI (US); Aaron DeLong, Toledo, OH (US); John Robert Van Wiemeersch, Novi, MI (US)

(73) Assignee: Ford Global Technologies, LLC, Dearborn, MI (US)

(21) Appl. No.: 16/812,893

(22) Filed: Mar. 9, 2020

(51) Int. Cl. B60R 25/40; B60R 25/24; B60R 25/20

(52) U.S. Cl. CPC B60R 25/406; B60R 25/24; B60R 2325/105; B60R 2325/205; B60R 2325/101; B60R 25/209

(57) ABSTRACT

The disclosure is generally directed to systems and methods for reducing power consumption in a smart key of a vehicle. In an exemplary method, an accelerometer in the smart key detects that the smart key is moving. For example, an individual may be carrying the smart key in his/her pocket and walking towards the vehicle. However, an RF transceiver circuit of the smart key may be out of range of a communication system in the vehicle. A processor in the smart key may place some circuits, such as a wakeup receiver, in a power-down condition, based on detecting the moving state of the smart key and a lack of communications between the Bluetooth® transceiver circuit and the communication system of the vehicle. The wakeup receiver typically has a smaller operating range than the RF transceiver circuit and is therefore unnecessary when the smart key is far from the vehicle.

### FIELD OF THE DISCLOSURE

This disclosure generally relates to operations associated with a vehicle and more particularly relates to systems for reducing power consumption in a smart key of a vehicle.

### BACKGROUND

Power consumption is typically a major issue in battery-operated devices, such as smart keys, which are used to execute various operations upon a vehicle. For example, a smart key may be used to unlock or lock the doors of a vehicle without necessitating depression of any buttons on the smart key. The smart key can also be carried in a driver's pocket and used to start the engine of the vehicle without inserting a traditional key into the ignition lock. As a part of such a starting procedure, a first circuit that is provided in the smart key detects a signal that is transmitted by a computer system of the vehicle. A second circuit in the smart key then communicates with the computer system of the vehicle for allowing the computer system to carry out operations, such as authentication of the smart key and activation of the engine of the vehicle.

It would be advantageous to extend the battery life of a battery in the smart key by powering down all circuits when the smart key is not in use. However, such an action can be challenging to implement because at least the first circuit in the smart key has to be left on at all times in order to detect the signal transmitted by the computer system of the vehicle at any random instant. It is therefore desirable to provide solutions that address such issues when attempting to reduce power consumption in a smart key.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 shows an exemplary vehicle that supports various actions performed by using a smart key.

FIG. 2 shows some exemplary components that may be included in a smart key in accordance with the disclosure.

FIG. 3 shows an exemplary scenario where power consumption operations in accordance with the disclosure may be carried out upon a smart key that is being carried by an individual moving towards a vehicle.

FIG. 4 shows an exemplary scenario where power consumption operations in accordance with the disclosure may be carried out when more than one smart key is present inside a vehicle.

FIG. 5 shows a flowchart of an exemplary method for reducing power consumption in a smart key in accordance with the disclosure.

FIG. 6 shows a flowchart of another exemplary method for reducing power consumption in a smart key in accordance with the disclosure.

### DETAILED DESCRIPTION

### Overview

In terms of a general overview, this disclosure is directed to systems and methods related to reducing power consumption in a smart key of a vehicle. In an exemplary method in accordance with the disclosure, an accelerometer that is a part of the smart key detects that the smart key is in a moving state. For example, an individual may be carrying the smart key in his/her pocket and walking towards the vehicle. However, the individual may be far enough from the vehicle that a Bluetooth® transceiver circuit of the smart key is unable to communicate with a communication system in the vehicle. A processor in the smart key may place some circuits in the smart key in a power-down state based on detecting the moving state of the smart key and the lack of communications between the Bluetooth® transceiver circuit and the communication system in the vehicle. The circuits that are powered down in the smart key can include a wakeup receiver. The wakeup receiver typically has a smaller operating range than the Bluetooth® transceiver circuit and is therefore unnecessary when the smart key is out of range of the Bluetooth® transceiver circuit. The wakeup receiver may be powered back up when the accelerometer detects the moving state of the smart key and the Bluetooth® transceiver circuit starts actively communicating with the computer system of the vehicle. In another method in accordance with the disclosure, the processor may retain the wakeup receiver in the power-down state when the wakeup receiver is out of range of the computer system in the vehicle, even if the Bluetooth® transceiver circuit is actively communicating with the computer system of the vehicle. The wakeup receiver may be powered up when the smart key is within a threshold distance of the vehicle. The threshold distance may be defined by an operating range of the wakeup receiver.

### Illustrative Embodiments

The disclosure will be described more fully hereinafter with reference to the accompanying drawings, in which exemplary embodiments of the disclosure are shown. This disclosure may, however, be embodied in many different forms and should not be construed as limited to the exemplary embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described exemplary embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the phrase “Bluetooth® transceiver” as used herein in the context of communication devices is not intended to preclude other forms of communication devices and communication formats, such as for example, Wi-Fi transceivers, Ultra-Wideband (UWB) transceivers, and RF transceivers that operate at various frequencies for carrying out wireless communications. It should be understood that some or all of the description provided herein with respect to a “smart key” is equally applicable to various devices that may be referred to as a passive entry passive start (PEPS) device or a phone-as-a-key (PaaK) for example, and used to carry out various actions with respect to a vehicle. A smart key may sometimes be referred to in popular parlance as an “intelligent” key or a key “fob.” It should also be understood that the word “example” as used herein is intended to be non-exclusionary and non-limiting in nature. More particularly, the word “exemplary” as used herein indicates one among several examples, and it should be understood that no undue emphasis or preference is being directed to the particular example being described.

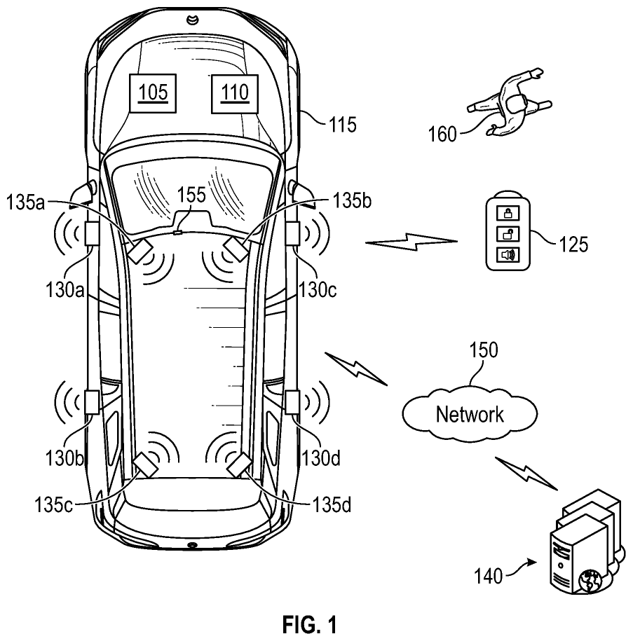

FIG. 1 shows an exemplary vehicle 115 that supports various actions performed by use of a smart key 125. The vehicle 115 may be any of various types of vehicles such as a gasoline powered vehicle, an electric vehicle, a hybrid electric vehicle, or an autonomous vehicle, and may include components such as a vehicle computer 110, an auxiliary operations computer 105, and a wireless communication system. The vehicle computer 110 may perform various functions such as controlling engine operations (fuel injection, speed control, emissions control, braking, etc.), managing climate controls (air conditioning, heating etc.), activating airbags, and issuing warnings (check engine light, bulb failure, low tire pressure, vehicle in blind spot, etc.). In some cases, the vehicle computer 110 may include more than one computer such as, for example, a first computer that controls engine operations and a second computer that operates an infotainment system in the vehicle 115.

The auxiliary operations computer 105 may be configured to interact with various types of components in the vehicle 115. For example, the auxiliary operations computer 105 may be configured to control certain components that are associated with operations such as locking and unlocking of the doors of the vehicle 115, and enabling an engine-start push-button 155 in the vehicle 115 when the smart key 125 is present inside a cabin of the vehicle 115 or an authorized vehicle access event has occurred within a specified recent period.

In an exemplary implementation in accordance with the disclosure, the auxiliary operations computer 105 may include circuitry that supports wireless communications between the vehicle 115 and remote control devices such as the smart key 125. A first set of wireless communication nodes 130a, 130b, 130c, and 130d may be provided on the body of the vehicle 115. Some or all of the wireless communication nodes 130a, 130b, 130c, and 130d may support low frequency (LF) wireless communications and/or RF communications between the auxiliary operations computer 105 and the smart key 125. Alternatively, a single wireless communication node may be mounted upon the roof of the vehicle 115.

The smart key 125 may communicate with the vehicle computer 110 via one or more of the first set of wireless communication nodes 130a, 130b, 130c, and 130d so as to allow, for example, an individual 160 to unlock a door of the vehicle 115 before entering the vehicle 115, and/or to authenticate the smart key 125. A radiation pattern of each of the antennas in the wireless communication nodes 130a, 130b, 130c, and 130d may be oriented outwards so as to provide the greatest wireless coverage outside the vehicle 115.

A second set of wireless communication nodes 135a, 135b, 135c, and 135d may be used to provide wireless coverage in the cabin area of the vehicle 115. A radiation pattern of each of the antennas in the wireless communication nodes 135a, 135b, 135c, and 135d may be oriented in a manner that provides optimized wireless coverage inside the vehicle. Some or all of the wireless communication nodes 135a, 135b, 135c, and 135d may support low frequency (LF) wireless communications and/or RF communications between the auxiliary operations computer 105 and the smart key 125 for purposes such as locating one or more smart keys in the cabin area, locating one or more smart keys near the exterior of a door, and/or to transmit signals such as an authentication signal or a shutdown signal, to a smart key that is in the cabin area.

In one version, the smart key 125 may allow the individual 160 to unlock a door of the vehicle 115 by depressing a door unlock button on the smart key 125 or, when the smart key is within a specified distance from the vehicle, by depressing a door unlock button on the vehicle exterior. In another version, the smart key 125 automatically unlocks a door of the vehicle 115 when the individual 160 approaches the vehicle. The smart key 125 may further include various other buttons such as a door lock button, an engine start button, and a panic button, that may be depressed by the individual 160. The smart key 125 may also include circuitry configured for use to start the vehicle 115 when the individual 160 is seated inside the vehicle 115. This operation may be carried out by the auxiliary operations computer 105 sensing the presence of the smart key 125 inside the vehicle 115 and enabling the engine-start push-button 155 to allow the individual 160 to start the vehicle 115.

In an exemplary operation that is directed at locating one or more smart keys in the cabin area of the vehicle 115, the auxiliary operations computer 105 may use three or more of the wireless communication nodes 135a, 135b, 135c, and 135d to carry out a received signal strength indication (RSSI) and/or a time-of-flight (ToF) trilateration or and/or angle of arrival/departure (AoA/AoD) triangulation procedure. For example, the RSSI and/or ToF trilateration or AoA/AoD triangulation procedure may allow the auxiliary operations computer 105 to locate and identify a first smart key carried by a driver in the vehicle 115 and a second smart key carried by a passenger in the vehicle 115.

The auxiliary operations computer 105 is communicatively coupled to a server computer 140 via a network 150. The network 150 may include any one, or a combination of networks, such as a local area network (LAN), a wide area network (WAN), a telephone network, a cellular network, a cable network, a wireless network, and/or private/public networks such as the Internet. For example, the network 150 may support communication technologies such as Bluetooth®, cellular, near-field communication (NFC), Wi-Fi, Wi-Fi direct, Ultra-Wideband (UWB), machine-to-machine communication, and/or man-to-machine communication. At least one portion of the network 150 includes a wireless communication link that allows the server computer 140 to communicate with one or more of the wireless communication nodes 130a, 130b, 130c, and 130d on the vehicle 115. The server computer 140 may communicate with the auxiliary operations computer 105 and/or other devices for various purposes such as for obtaining information about the vehicle 115 and/or the individual 160.

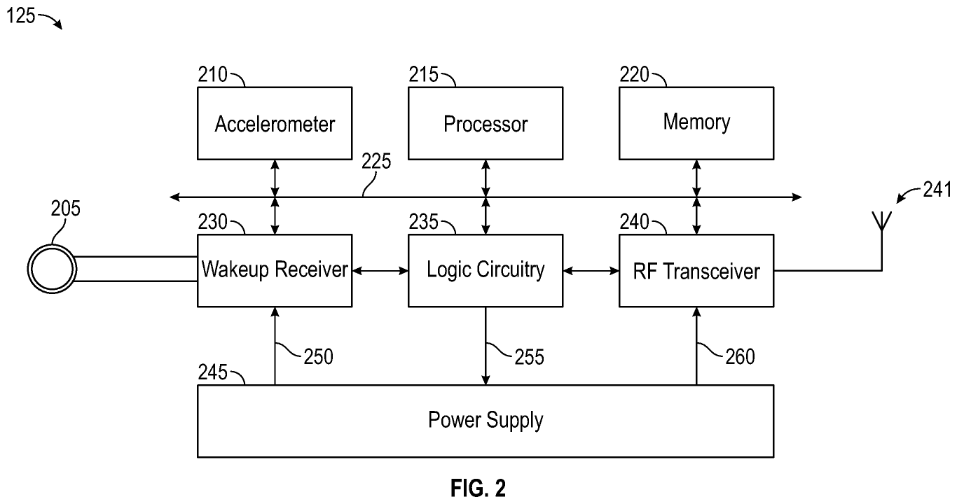

FIG. 2 shows some exemplary components that may be included in the smart key 125 in accordance with the disclosure. The exemplary components may include a power supply 245, an accelerometer 210, a wakeup receiver 230, logic circuitry 235, an RF transceiver 240, a processor 215, and a memory 220. The various components may communicate with each other via a bus 225.

The power supply 245, which can include one or more batteries, is configured to provide power to all the active components of the smart key 125. For example, the power supply 245 can provide power to the wakeup receiver 230 via a line 250, and to the RF transceiver 240 via a line 260. Power may be similarly provided to the processor 215 and the memory 220.

Logic circuitry 235 may provide control signals to the power supply 245 via a line 255. The control signals may configure the power supply 245 to selectively turn on, or turn off, power to the wakeup receiver 230 and/or the RF transceiver 240 under various conditions in accordance with this disclosure. Logic circuitry 235 can also operate as an interface for propagating communication signals from the wakeup receiver 230 to the RF transceiver 240 that is coupled to an RF antenna 241.

The accelerometer 210 can be used to sense various types of movements of the smart key 125. For example, the accelerometer 210 may sense that the smart key 125 is in a moving condition when the smart key 125 is carried around by the individual 160 outside the vehicle 115. The moving condition may also occur when the individual 160 has placed the smart key 125 in his/her pocket and is moving his/her body when seated inside the vehicle 115. Upon sensing these types of moving conditions, the accelerometer 210 generates a sense signal that can be communicated to the processor 215, via the bus 225.

The wakeup receiver 230 is typically a low-frequency (LF) receiver that is coupled to a loop antenna 205. The loop antenna 205 can receive low frequency signals transmitted by the auxiliary operations computer 105 through the first set of wireless communication nodes 130a, 130b, 130c, and 130d and/or the second set of wireless communication nodes 135a, 135b, 135c, and 135d.

In an exemplary sequence of operations that can be performed by the smart key 125, the wakeup receiver 230 receives an LF signal when the processor 215 and some other components of the smart key 125 are in a powered-down condition. Upon receiving the LF signal, the wakeup receiver 230 wakes up the processor 215, which then executes a program stored in the memory 220 in order to measure RSSI values of the received signals. Information derived from this program execution is conveyed to the RF transceiver 240. The RF transceiver 240 uses this information to transmit RSSI values to the auxiliary operations computer 105 in the vehicle 115. The RSSI values may be used by the auxiliary operations computer 105 to determine a location of the smart key 125.

The RF transceiver 240 can be an ultra-high frequency (UHF) transceiver in some applications and a Bluetooth® Low Energy (BLE) transceiver in some other applications. Typically, the signal coverage area of the RF transceiver 240 (either UHF or Bluetooth®) is significantly greater than the signal coverage area of the wakeup receiver 230. Consequently, the smart key 125 can maintain signal communications with the auxiliary operations computer 105 even when the wakeup receiver 230 is out of range and is unable to receive LF signals from the auxiliary operations computer 105.

In a conventional PEPS scenario, the wakeup receiver 230 is placed in a permanent powered-up state for receiving low frequency (LF) signals from the wireless communication nodes, which can arrive at any time. In this scenario, the power consumption of the smart key 125 is high because the wakeup receiver 230 typically consumes almost half of the power consumption of the smart key 125. The RF transceiver 240 can also consume a significant amount of power when Bluetooth® or UHF communication is used.

It is therefore desirable to selectively place the wakeup receiver 230 and/or the RF transceiver 240 in a powered down condition for purposes of extending battery life in the smart key 125. Accordingly, in a first exemplary method in accordance with the disclosure, the accelerometer 210 is used to detect a moving state of the smart key 125. The moving state may occur, for example, when the individual 160 is carrying the smart key 125 in his/her pocket and is walking away from the vehicle 115. At this time, the individual 160 may be far from the vehicle 115 and the RF transceiver 240 is unable to communicate with the wireless communication nodes of the vehicle 115 using RF signals such as Bluetooth® or UHF. The wakeup receiver 230, which operates using LF signals, has a smaller operating range than the RF transceiver 240 and it is therefore unnecessary to retain the wakeup receiver 230 in a powered up state when the RF transceiver 240 is not in communication with the wireless communication nodes of the vehicle 115.

In this scenario, the processor 215 interacts with the logic circuitry 235 to transmit a trigger signal to the power supply via the line 255. The power supply 245 may then place some of the circuits in the smart key 125 in a power-down state. The circuits that are powered down in the smart key 125 may particularly include the wakeup receiver 230, thereby reducing a power drain on the batteries contained in the power supply 245.

The wakeup receiver 230 may be powered back up when the accelerometer 210 detects the moving state of the smart key 125 and the RF transceiver 240 starts communicating with the wireless communication nodes of the vehicle 115. Thus, for example, when the RF transceiver 240 uses Bluetooth®, the wakeup receiver 230 may be powered back up when the accelerometer 210 detects a moving state of the smart key 125 and a Bluetooth® connection has been established between the RF transceiver 240 and a communication node of the vehicle 115.

The processor 215 may retain the wakeup receiver 230 in the power-down state when the wakeup receiver 230 is out of range of the wireless communication nodes of the vehicle 115, irrespective of the communication status of the RF transceiver 240. For example, the wakeup receiver 230 may be retained in the power-down state when the smart key 125 is located beyond a threshold distance from the vehicle 115, even when a Bluetooth® connection has been established between the RF transceiver 240 and a communication node of the vehicle 115. The threshold distance may be defined by an operating characteristic of the wakeup receiver 230, such as, for example, an LF signal detection sensitivity or certain RSSI value. The wakeup receiver 230 may be powered back up when the smart key 125 moves closer to the vehicle 115 and is inside the threshold distance.

The memory 220, which is one example of a non-transitory computer-readable medium, may be used to store an operating system (OS) and various code modules such as a power consumption reduction module and a location identification module. The code modules are provided in the form of computer-executable instructions that can be executed by the processor 215 for performing various operations in accordance with the disclosure.

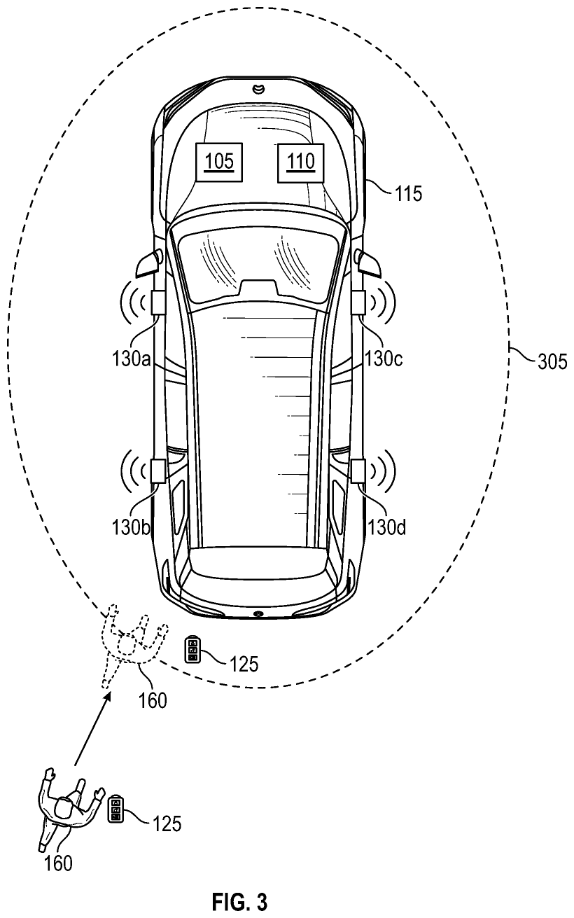

FIG. 3 shows an exemplary scenario where power consumption operations in accordance with the disclosure may be carried out upon the smart key 125 that is being carried by the individual 160 moving towards the vehicle 115. In this exemplary scenario, the RF transceiver 240 uses Bluetooth® communication and the individual 160 is currently located beyond a threshold distance 305 of the vehicle 115. A Bluetooth® connection has been established between the RF transceiver 240 and one or more of the wireless communication nodes 130a, 130b, 130c, and 130d. The Bluetooth® connection may also be established with other devices in the vehicle 115, such as, for example, the vehicle computer 110 and/or the auxiliary operations computer 105. In accordance with the disclosure, the processor 215 may execute the location identification module stored in the memory 220, so as to identify the current location of the smart key 125. RSSI and/or ToF and/or AoA/AoD techniques may be used for this purpose. The processor 215 may then place (or retain) the wakeup receiver 230 in the power down condition even though the accelerometer 210 in the smart key 125 detects the moving state of the smart key 125 and Bluetooth® connection has been established. The wakeup receiver 230 may be powered up by the processor 215 when the individual 160 approaches the vehicle 115 and the smart key 125 is located at a spot that is less than the threshold distance 305.

The power reduction scenarios described herein, which are directed at reducing battery drain, may be complemented in some cases, by charging the batteries of the power supply 245 via power harvesting of RF signals received by the RF transceiver 240. The RF signals may be Bluetooth® signals and in at least some cases, the amount of power harvested from these signals may be adequate to power the wakeup receiver 230.

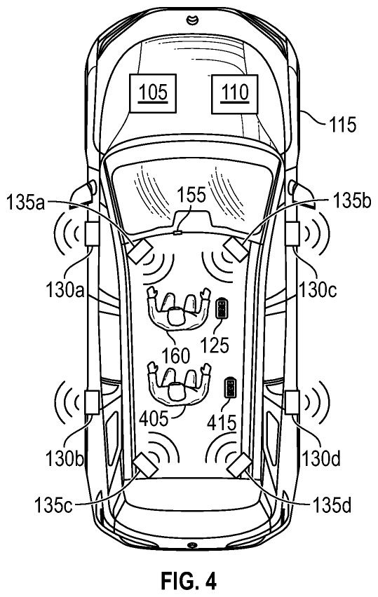

FIG. 4 shows an exemplary scenario where power consumption operations in accordance with the disclosure may be carried out when more than one smart key is present inside the vehicle 115. In this example, the individual 160 who is carrying the smart key 125 is seated in the driver seat. Another individual 405, who is seated in a passenger seat, is carrying another smart key 415. The auxiliary operations computer 105 may use the wireless communication nodes 135a, 135b, 135c, and 135d to execute a location procedure for determining that both smart keys are located inside the cabin of the vehicle 115 and that each of the smart keys is in a stationary state. The auxiliary operations computer 105 may then send a command signal to the smart key 415 to power down one or more circuits in the smart key. More particularly, the wakeup receiver and/or the RF transceiver of the smart key 415 may be powered down so as to reduce power consumption in the smart key 415.

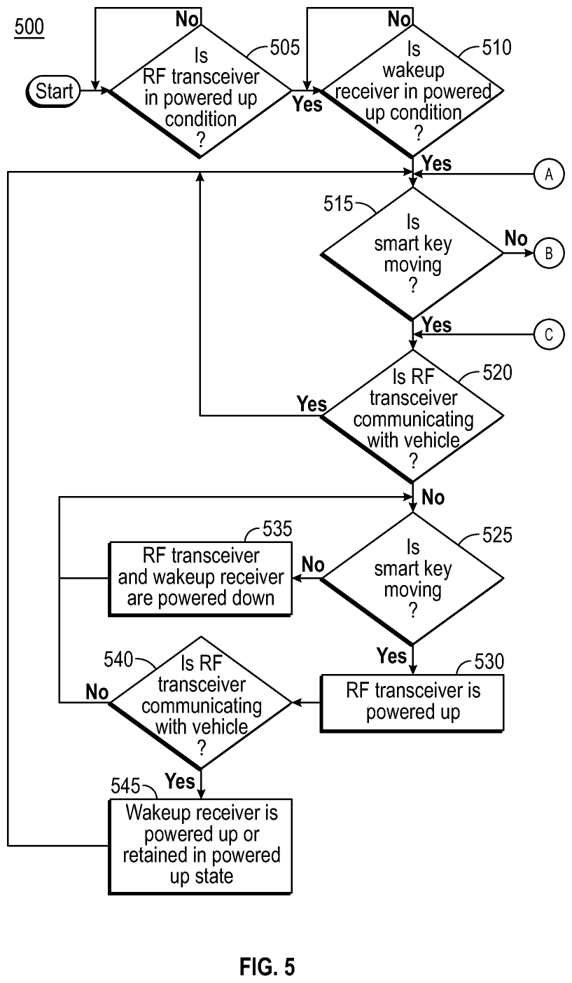

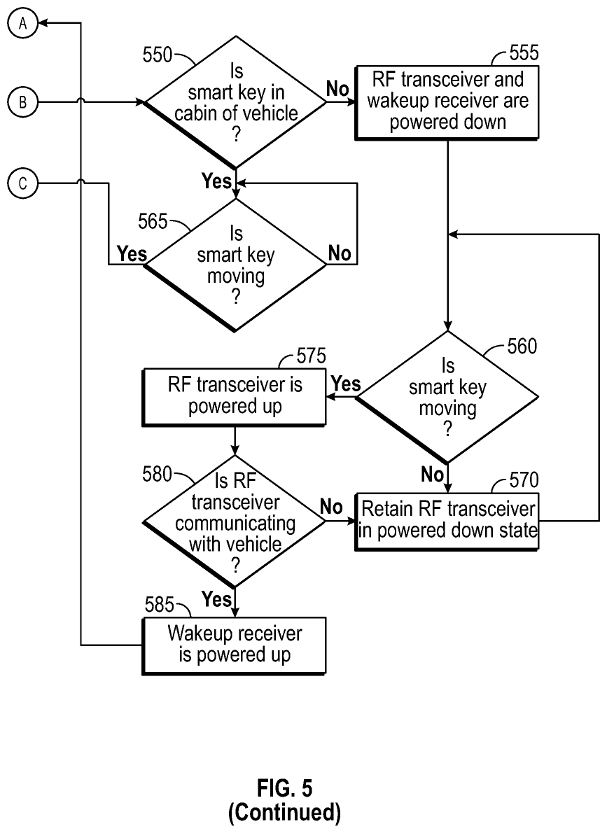

FIG. 5 shows a flowchart 500 of an exemplary method for reducing power consumption in the smart key 125 in accordance with the disclosure. The flowchart 500 illustrates a sequence of operations that can be implemented in hardware, software, or a combination thereof. In the context of software, the operations represent computer-executable instructions stored on one or more non-transitory computer-readable media such as the memory 220, that, when executed by one or more processors such as the processor 215, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. The description below may make reference to certain components and objects shown in FIGS. 1-4, but it should be understood that this is done for purposes of explaining certain aspects of the disclosure and that the description is equally applicable to many other embodiments.

At block 505, a determination may be made whether the RF transceiver 240 is in a powered up condition. If the RF transceiver 240 in a powered up condition, at block 510, a determination may be made whether the wakeup receiver 230 is in a powered up condition. At block 515, a determination is made whether the smart key 125 is in a moving state. If the smart key 125 is not in a moving state, at block 550, a determination may be made whether the smart key 125 is inside the cabin of the vehicle 115. If the smart key 125 is not inside the cabin of the vehicle 115, at block 555, the wakeup receiver 230 and the RF transceiver 240 may be powered down.

After the wakeup receiver 230 and the RF transceiver 240 are powered down, at block 560, a determination may be made whether the smart key 125 is moving. If the smart key 125 is not moving, at block 570, the RF transceiver 240 is retained in the power down condition. However, if the smart key 125 is moving, at block 575, the RF transceiver 240 is powered up. At block 580, a determination may be made whether the RF transceiver 240 has established a connection with one or more of the wireless communication nodes 130a, 130b, 130c, and 130d. In one exemplary case, the connection is indicated by establishment of a Bluetooth® connection between the RF transceiver 240 and one or more of the wireless communication nodes 130a, 130b, 130c, and 130d. If the RF transceiver 240 has not established a connection with one or more of the wireless communication nodes 130a, 130b, 130c, and 130d, at block 580, then at block 570, the RF transceiver is powered down. However, if the RF transceiver 240 has established a connection with one or more of the wireless communication nodes 130a, 130b, 130c, and 130d, at block 585, the wakeup receiver 230 is powered up.

After powering up the wakeup receiver, at block 515, a determination is made whether the smart key 125 is moving. If the smart key is moving, at block 520, a determination may be made whether the RF transceiver 240 has established a connection with one or more of the wireless communication nodes 130a, 130b, 130c, and 130d. If the RF transceiver 240 has established a connection, at block 515, a determination is made whether the smart key 125 is moving. If the RF transceiver 240 has not established a connection, at block 525, a determination is made whether the smart key 125 is moving.

If the smart key 125 is not moving, at block 535, the RF transceiver 240 and the wakeup receiver 230 are powered down. After powering down the RF transceiver 240 and the wakeup receiver 230, at block 525, a determination is made whether the smart key 125 is moving. If the smart key 125 is moving, at block 530, the RF transceiver 240 is powered up.

At block 540, a determination may be made whether the RF transceiver 240 has established a connection with one or more of the wireless communication nodes 130a, 130b, 130c, and 130d. If the RF transceiver 240 has not established a connection, at block 525, a determination is made whether the smart key 125 is moving. If the RF transceiver 240 has established a connection, at block 545, the wakeup receiver 230 is retained in the powered up condition. A determination may then be made at block 515 to determine if the smart key 125 is moving.

Drawing attention back to the determination made at block 550 whether the smart key 125 is in the cabin, if the smart key 125 is inside the cabin, at block 565, a determination is made whether the smart key 125 is moving. If not moving, continuous monitoring of the smart key 125 is carried out to determine if the smart key 125 begins to move. If the smart key 125 begins to move, at block 520, a determination may be made whether the RF transceiver 240 has established a connection with one or more of the wireless communication nodes 130a, 130b, 130c, and 130d. If the RF transceiver 240 has established a connection, subsequent operations that are described above may then be carried out.

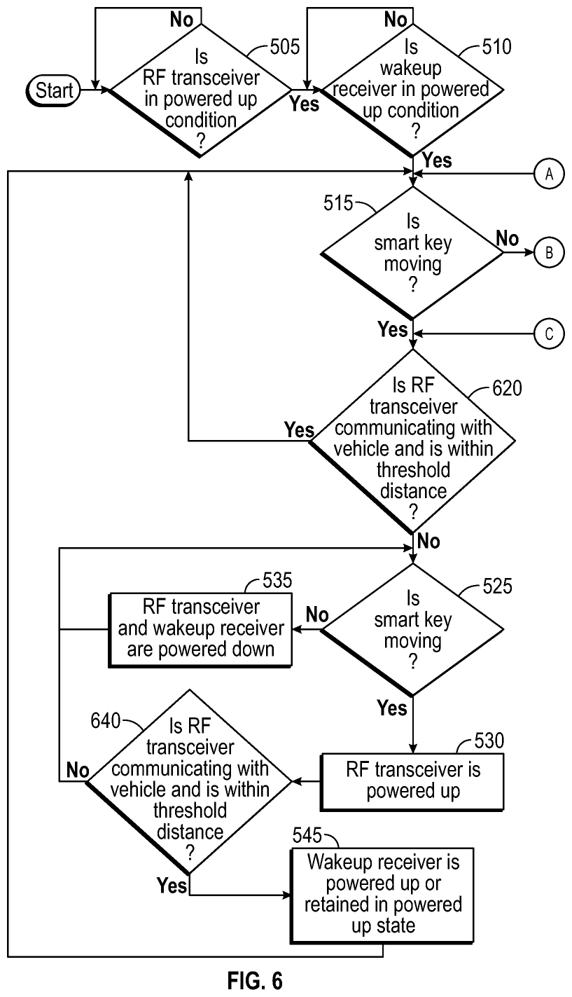

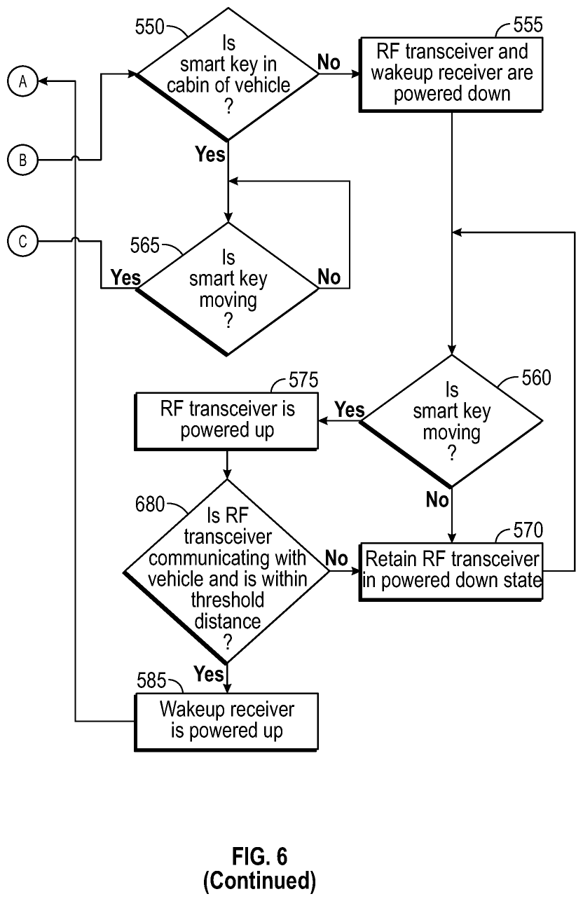

FIG. 6 shows a flowchart 600 of another exemplary method for reducing power consumption in the smart key 125 in accordance with the disclosure. The flowchart 600 is substantially similar to the flowchart 500 described above, except for operations described with respect to blocks 520, 540, and 580 that are replaced by blocks 620, 640, and 680 in flowchart 600. Specifically, at each of blocks 620, 640, and 680, a determination may be made whether the RF transceiver 240 has established a connection with one or more of the wireless communication nodes 130a, 130b, 130c, and 130d and also whether the smart key 125 is within a threshold distance of the vehicle 115. Details pertaining to the threshold distance are described above with reference to FIG. 3.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device such as the memory 220, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A method for reducing power consumption in a smart key of a vehicle, the method comprising:
detecting, by an accelerometer in the smart key, whether the smart key is in a moving state;
detecting, by a processor in the smart key, whether the smart key is actively communicating with a communication system located in the vehicle;
determining a distance between the smart key and the vehicle; and
placing one or more circuits inside the smart key in a power-down condition when the smart key is in the moving state and actively communicating with the communication system, and the distance between the smart key and the vehicle exceeds a threshold distance.

2. The method of claim 1, wherein the one or more circuits inside the smart key comprise one of an RF transceiver or a wakeup receiver, the method further comprising:
placing the one of the RF transceiver or the wakeup receiver in a powered condition when the smart key is in the moving state and actively communicating with the communication system and the distance between the smart key and the vehicle is less than the threshold distance.

3. The method of claim 1, wherein the processor determines that the smart key is located outside the vehicle and is out of range of the communication system when the smart key is in the moving state and not actively communicating with the communication system.

4. The method of claim 1, wherein the smart key is one of a passive entry passive start (PEPS) device or a phone-as-a-key (PaaK) that uses an RF transceiver to communicate with the communication system located in the vehicle.

5. The method of claim 4, wherein the one or more circuits that are placed in the power-down condition comprise a wakeup receiver circuit.

6. The method of claim 5, further comprising:
retaining the wakeup receiver circuit and the RF transceiver in a powered condition when the smart key is actively communicating with the communication system and the distance between the smart key and the vehicle is less than the threshold distance.

7. The method of claim 5, further comprising:
placing at least the wakeup receiver circuit in the power-down condition when the smart key is not actively communicating with the communication system and the distance between the smart key and the vehicle exceeds the threshold distance that is defined at least in part, by an operating range of the wakeup receiver circuit in the smart key.

8. A method for reducing power consumption in one or more smart keys of a vehicle, the method comprising:
detecting, by a first processor in a first smart key, whether the first smart key is actively communicating with a communication system located in the vehicle;
determining a distance between the first smart key and the vehicle; and
placing one or more circuits inside the first smart key in a power-down condition when the first smart key is in a moving state, and actively communicating with the communication system and the distance between the first smart key and the vehicle exceeds a threshold distance.

9. The method of claim 8, further comprising:
using an accelerometer in the first smart key to detect whether the first smart key is in the moving state; and
placing the one or more circuits inside the first smart key in the power-down condition when the first smart key is in the moving state and the first smart key is not actively communicating with the communication system located in the vehicle.

10. The method of claim 9, wherein the communication system located in the vehicle is a Bluetooth® communication system that communicates with a Bluetooth® transceiver circuit in the first smart key, and wherein the threshold distance is defined at least in part, by an operating range of a wakeup receiver circuit provided in the first smart key.

11. The method of claim 10, wherein the one or more circuits inside the first smart key placed in the power-down condition is the wakeup receiver circuit.

12. The method of claim 8, further comprising:
using an accelerometer in the first smart key to detect whether the first smart key is in the moving state; and
retaining the one or more circuits inside the first smart key in a powered condition when the first smart key is not in the moving state, the first smart key is actively communicating with the communication system located in the vehicle, and the distance between the first smart key and the vehicle is lower than the threshold distance that is defined at least in part, by an operating range of a wakeup receiver circuit provided in the first smart key.

13. The method of claim 12, further comprising:
detecting that the first smart key is located inside the vehicle when the first smart key is not in the moving state.

14. The method of claim 13, further comprising:
detecting by a second processor in the communication system, a second smart key located inside the vehicle when the first smart key is not in the moving state, wherein the second smart key is in a stationary state;
detecting, by the second processor in the communication system, that the second smart key is actively communicating with the communication system located in the vehicle; and
placing the second smart key in a powered-down condition.

15. A smart key comprising:
an accelerometer;
a wakeup receiver circuit;
a transceiver circuit;
a memory that stores computer-executable instructions; and
a processor configured to access the memory and execute the computer-executable instructions to at least:
detect, by the accelerometer, whether the smart key is in a moving state;
detect whether the smart key is actively communicating with a communication system located in a vehicle;
determine a distance between the smart key and the vehicle; and
place at least the wakeup receiver circuit in a power-down condition when the smart key is in the moving state and actively communicating with the communication system located in the vehicle, and the distance between the smart key and the vehicle exceeds a threshold distance.

16. The smart key of claim 15, wherein the communication system located in the vehicle is a Bluetooth® communication system and the smart key is one of a passive entry passive start (PEPS) device or a phone-as-a-key (PaaK) that uses Bluetooth® communication to communicate with the Bluetooth® communication system located in the vehicle.

17. The smart key of claim 16, wherein the transceiver circuit in the smart key is a Bluetooth® transceiver circuit.

18. The smart key of claim 16, wherein the processor further executes the computer-executable instructions to:
retain the wakeup receiver circuit and the transceiver circuit in a powered condition when the smart key is in the moving state and actively communicating with the communication system located in the vehicle, and the distance between the smart key and the vehicle is less than the threshold distance.

19. The smart key of claim 15, wherein the processor further executes the computer-executable instructions to:
retain the wakeup receiver circuit and the transceiver circuit in a powered condition when the smart key is actively communicating with the communication system and the distance between the smart key and the vehicle is less than the threshold distance.

20. The smart key of claim 19, wherein the threshold distance is defined at least in part, by an operating range of the wakeup receiver circuit.
